(19) United States
(12) Patent Application Publication
(10) Pub. No.: US 2005/0274762 A1
(43) Pub. Date: Dec. 15, 2005

(54) Vehicle container

(76) Inventors: Paul Belokin, Denton, TX (US); Martin P. Belokin, Denton, TX (US); Norman P. Belokin, Corinth, TX (US)

Correspondence Address: HUNTON & WILLIAMS LLP, 1601 BRYAN STREET, ENERGY PLAZA - 30TH FLOOR, DALLAS, TX, 75201, US

(21) Appl. No.: 10/867,504

(22) Filed: Jun. 14, 2004

(51) Int. Cl. B60R 7/00

(52) U.S. Cl. 224/543

(57) ABSTRACT

A vehicle container has been provided that, in an exemplary implementation, includes a mounting surface, one or more container walls, and an attachment device. The attachment device mounts the mounting surface and container walls to a surface of the vehicle. The container walls and the mounting surface are configured such that a container space or volume is created by a surface of a vehicle and the container walls. In one configuration, the attachment device is not positioned between the container space and the surface of the vehicle. A method of making a container space or volume is also provided.

### TECHNICAL FIELD OF THE INVENTION

The present invention relates generally to the field of containers, and more particularly, but not by way of limitation, to vehicle containers.

### BACKGROUND OF THE INVENTION

The limited space within a vehicle can make it difficult to keep personal items and travel essentials organized. While typical vehicles offer a glove compartment and cup holders, many things kept in a vehicle are unfortunately consigned to the floor, dashboard or an empty seat. The glove compartments and cup holders simply do not provide enough room; and, they are not particularly suited to hold many types of travel items that individuals either currently take along or would like to take along in vehicles. Many types of vehicles need additional space for storing objects, including trucks, automobiles, recreational vehicles, boats and other types of vehicles.

### SUMMARY OF THE INVENTION

From the foregoing it may be appreciated that a need has arisen for a vehicle container and a method of creating a container space. In accordance with the present invention, a vehicle container and a method of creating a container space are provided that substantially eliminate one or more of the disadvantages and problems outlined above.

According to an aspect of the present invention, a container has been provided that comprises a mounting surface, at least one container wall, and an attachment device. The at least one container wall is coupled to the mounting surface using the attachment device. The attachment device is operable to couple the mounting surface to the surface of the vehicle. The at least one container wall and the mounting surface are configured such that a container space or volume is created or defined by at least a portion of the at least one container wall and at least a portion of the mounting surface of the vehicle when the container is coupled to the surface of the vehicle.

According to another aspect of the present invention, a container has been provided that comprises a mounting surface, at least one container wall, and an attachment device. At least a portion of the mounting surface is configured to compliment the surface of the vehicle. The attachment device is operable to couple the mounting surface to the surface of the vehicle. The at least one container wall is configured such that at least a portion of a container space or volume is created by at least a portion of the at least one container wall when the container is coupled to the surface of the vehicle. Additionally, the at least one container wall is coupled to the mounting surface; the container space is adjacent the surface of the vehicle; and the attachment device is not positioned between the container space and the surface of the vehicle.

In yet a further aspect of the invention, a method of creating a container space within a vehicle has been provided. The method comprises providing a mounting surface with at least one container wall coupled thereto; and mounting the mounting surface to a surface of the vehicle such that at least a portion of a surface of the vehicle and at least a portion of the at least one container wall form a container space.

The various embodiments and implementations of the present invention provide a profusion of potential technical advantages and benefits. A technical advantage of the present invention may include the capability to provide additional container space within a vehicle to hold various objects.

Another technical advantage of the present invention may include the capability to provide a vehicle container that is removable from a surface of a vehicle.

Another technical advantage of the present invention may include the capability to provide a vehicle container that conforms to surfaces of a vehicle.

Another technical advantage of the present invention may include the capability to provide a vehicle container which includes a logo or advertisement.

Yet another technical advantage of the present invention may include the capability to provide a vehicle container space, which utilizes a portion of a surface of the vehicle for the container space.

Still yet another technical advantage of the present invention may include the capability to provide a vehicle container that conforms to objects in which the container will hold.

Other technical advantages may be readily apparent to one skilled in the art after review of the following figures and description, associated herewith.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is a front perspective view of a vehicle container in isolation;

FIG. 2 is a cross-sectional view of the vehicle container cut across lines 2-2 of FIG. 1;

FIG. 3 is a back perspective view of a vehicle container;

FIG. 4 is a back perspective view of another embodiment of a vehicle container;

FIG. 5 is an illustrative view of a vehicle container mounted to a window;

FIG. 6 is an illustrative view of a vehicle container mounted to a visor;

FIG. 7 is an illustrative view of a vehicle container mounted to an internal roof of a vehicle;

FIG. 8 is an illustrative view of a vehicle container mounted to a dashboard;

FIGS. 9A, 9B, 9C, 9D, 9E, and 9F are illustrative views of exemplary attachment devices that can be utilized to mount a vehicle container to a surface of a vehicle;

FIG. 10 is an illustrative view of a logo that can be displayed on a wall of a vehicle container;

FIG. 11 is an illustrative view of a vehicle container having an opening in a wall for pulling tissues therethrough; and

FIG. 12 is an illustrative view of a configuration of a vehicle container utilized for holding beverage containers.

### DETAILED DESCRIPTION OF THE INVENTION

It should be understood at the outset that although an exemplary implementation of the present invention is illustrated below, the present invention may be implemented using any number of techniques, whether currently known or in existence. The present invention should in no way be limited to the exemplary implementations, drawings, and techniques illustrated below, including the exemplary design and implementations illustrated and described herein. Additionally, the drawings contained herein are not necessarily drawn to scale.

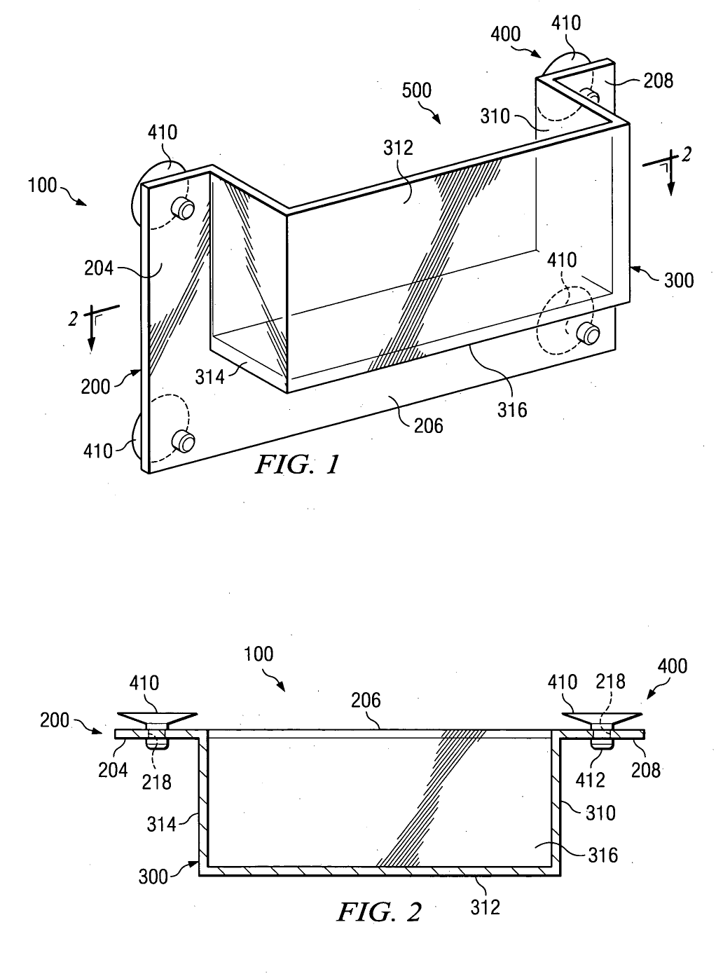

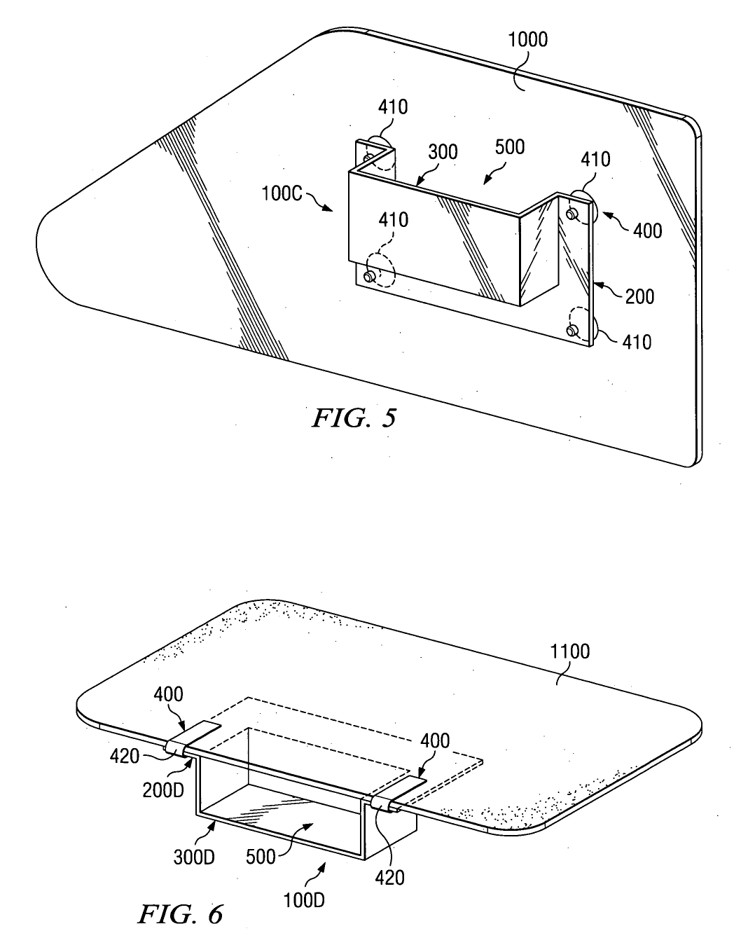

FIG. 1 and FIG. 2 generally show a configuration of a container 100, in isolation. The container 100 in this configuration comprises a mounting surface 200 and various container walls 300 that facilitate the creation of a container volume or space 500. The container 100 of FIGS. 1 and 2 can be mounted to a surface of a vehicle using an attachment device or devices 400. Such vehicles can include, but are not limited to, automobiles, pick-up trucks, freight trucks, recreational vehicles (RV), boats, sport utility vehicles (SUV), vans, minivans, airplanes, trains, motorcycles, and the like. The surface of the vehicle can be virtually any known or available vehicle surface, generally utilized in association with vehicles, including both external and internal vehicle surfaces. As an example and intended for illustrative purposes only, the surface of the vehicle can include, but is not limited to, windows, windshields, visors, dashboards, consoles, roofs, and the like. Other surfaces should become apparent to one of ordinary skill in the art after review of the specification, herein. Some of the above-referenced surfaces will be discussed below with reference to FIGS. 5-8. While the container 100 will be described below with reference to particular configurations, it should be understood that other configurations can be utilized as will be appreciated by one of ordinary skill in the art.

The container 100 is preferably made from transparent or translucent plastic material—e.g., injection molded acrylic—to permit visual inspection of the contents of the container 100 through the walls of the container 100; however, the container 100 can additionally be formed of opaque or semi-transparent materials. Such materials can include, but are not limited to, metals, plastics, papers, woods, and the like. The ultimate material utilized for the container may depend on the particular use in which the container will be imparted. While the container 100 is preferably made of a transparent material, the container 100 can additionally be made of opaque or tinted materials. Additionally, the container can have a base of one material and then be covered by another material. Furthermore, in some configurations of the container 100, items such as painted decals, logos, and the like may be placed at desired locations on the container 100.

The mounting surface or surfaces 200 of FIGS. 1 and 2 generally include a left mounting surface 204, a bottom mounting surface 206 and a right mounting surface 208. Other configurations for the mounting surface 200 should become apparent to one of ordinary skill in the art. As shown in FIGS. 1 and 2, the left mounting surface 204, bottom mounting surface 206 and right mounting surface 208 can be formed contiguously. In other configurations, however, component portions (e.g., left mounting surface 204, bottom mounting surface 206 and right mounting surface 208) of the mounting surface 200 may be separated.

The container walls 300 of FIGS. 1 and 2 generally include a left container wall 314, a bottom container wall 316, a right container wall 310 and a front container wall 312. While such a specific configuration of the container wall(s) 300 is shown in FIGS. 1 and 2, it should be understood that other configurations can additionally be utilized. For example, in some configurations of the invention, only one container wall 300 is utilized. And, in yet further configurations, container walls with varied shapes, sizes, and orientations are utilized. In the configuration of the container 100 of FIGS. 1 and 2, the left container wall 314, the bottom container wall 316, the right container wall 310 and the front container wall 312 may be formed or molded as one piece with the mounting surface 200. It will be appreciated, however, that container walls 300 may be formed independently and connected together by melding, glue, hinged clips or other angled surface connection schemes. The container walls 300 may be formed solidly, or may include holes, slots, perforations or cut-out design elements. For example, the bottom container wall 316 can include holes, such that liquids in the container space 500 may drain out through the holes in the bottom container wall 316.

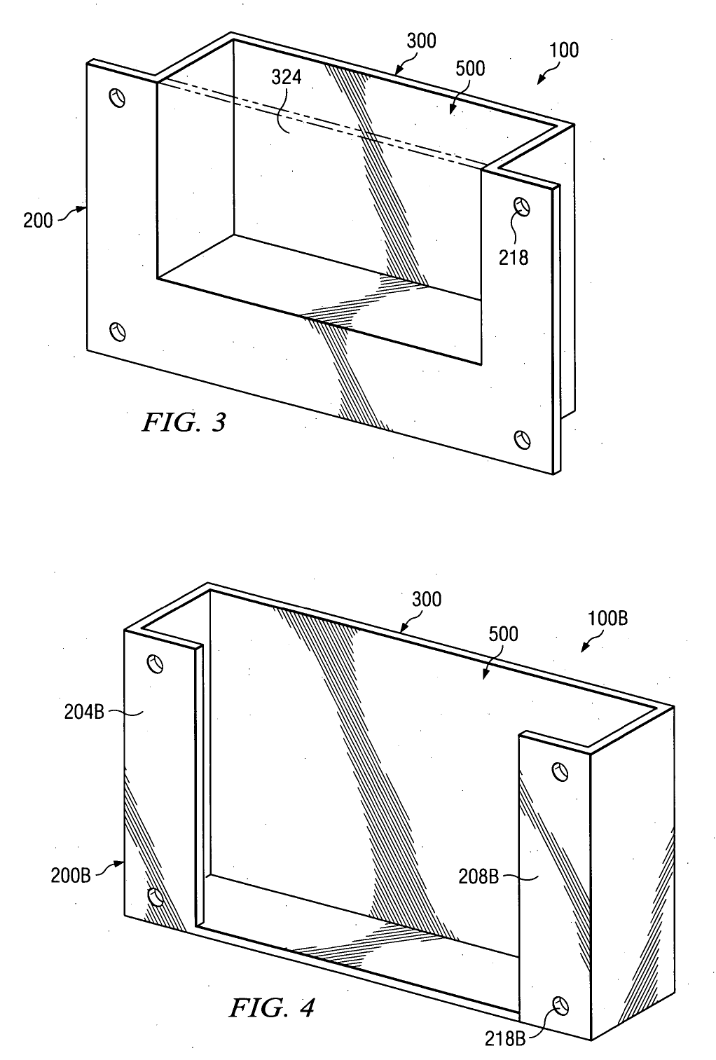

Attachment devices 400 generally facilitate the attachment of the container 100 to a surface of the vehicle. Virtually any attachment device 400 can be utilized. Illustrations of several such attachment devices 400 are described below with reference to FIGS. 9A-9F. To a certain degree, as discussed below, the particular attachment device 400 utilized can be dictated by the particular vehicle surface in which the container 100 will be mounted. The attachment devices 400 in the configuration of FIGS. 1 and 2 are shown as suction cups 410. The suction cups 410 in FIGS. 1 and 2 can be removably coupled to the mounting surfaces 200 via positioning a portion of the suction cups 410 through mounting holes, such as a mounting hole 218 of the left mounting surface 204. For example, a stem 412 on the suction cup 410 can be positioned through the mounting hole 218 (illustrated more fully in FIG. 3), whereby the mounting hole 218 resists retraction of the stem 412, holding the suction cup 410 in its desired position. Each suction cup 410, attached to the mounting holes of the container 100, may then be attached to the vehicle surface—allowing the mounting of the container 100 to the surface of the vehicle. The use of such suction cups 410 in other arrangements would be understood by one of ordinary skill in the art. The suction cup 410 may be provided in various sizes and designs. As an example, intended for illustrative purposes only, the body of a suction cup is usually made of rubber, plastic or other material having sufficiently resilient properties. When the body is pressed against a surface, the periphery of the suction cup is enlarged and the volume of concavity is reduced. Air or other fluid in the cup is expelled so that the body forms a tight seal against the applied surface. Atmospheric pressure outside the body retains the suction cup body against the surface. When the seal between the cup and the surface on which it is mounted is broken, fluids such as air or the like rush into the concavity, releasing the suction attachment to the surface and the resilient material of the suction cup body returns to its relaxed condition. With such an illustrative description, it will be appreciated that in some implementations, the attachment devices 400 are removable or adjustable.

Upon placement of the container 100 upon the surface of a vehicle, a container space or volume 500 is created. In the configuration of FIGS. 1 and 2, the container space or volume 500 will be defined by the container walls 300 (e.g., the left container wall 314, the bottom container wall 316, the right container wall 310 and the front container wall 312) and the surface of the vehicle. The container space or volume 500 may be rectangular or may take on any shape appropriate for the intended use. Additionally, the size of the container space or volume 500 may be chosen for the intended use. For example, the container 100 may be used to carry maps, books, papers, food, beverages, tissues, tools and the like. Other configurations of the container 100, which facilitate a creation of a container space or volume 500, will be described below. Openings may be provided in one or more of the walls that define the container space 500.

As the surface of the vehicle changes, the component parts of the container 100 can additionally change. For example, in some configurations, the mounting surfaces 200 can be configured to compliment the particular surface to which they will be mounted. In FIGS. 1 and 2, the mounting surface 200 generally compliments a flat or substantially planar surface. In other configurations (e.g., FIG. 8), the mounting surfaces 200 are configured to compliment another type of surface, namely a curved dashboard. The container walls 300 can similarly take on a variety of configurations, being specifically configured for a particular surface. Additionally, as referenced above, the attachment devices 400 can change to accommodate the vehicle surface to which the container 100 will be mounted. In such configurations, it should be understood that the various component parts can facilitate a complimenting of not only the shape of the surface, but also the particular material of which the vehicle surface is made.

FIG. 3 illustrates a back view of a configuration of the container 100 with the attachment devices 400 removed from the mounting holes such as the mounting hole 218. The container 100 is similar to FIGS. 1 and 2, including the mounting surface 200 and the container walls 300. Except, however, a back wall 324 is shown in phantom view, which can be utilized in some configurations to help form the container space or volume 500. In configurations in which a back wall 324 is utilized, the back wall 324 can be configured to conform to the vehicle surface to which it will be mounted.

FIG. 4 illustrates a configuration of a container 100B. The container 100B of FIG. 4 includes a mounting surface 200B that has a left mounting surface 204B and a right mounting surface 208B. The mounting surface 200B in the configuration of the container 100B helps define the container space 500.

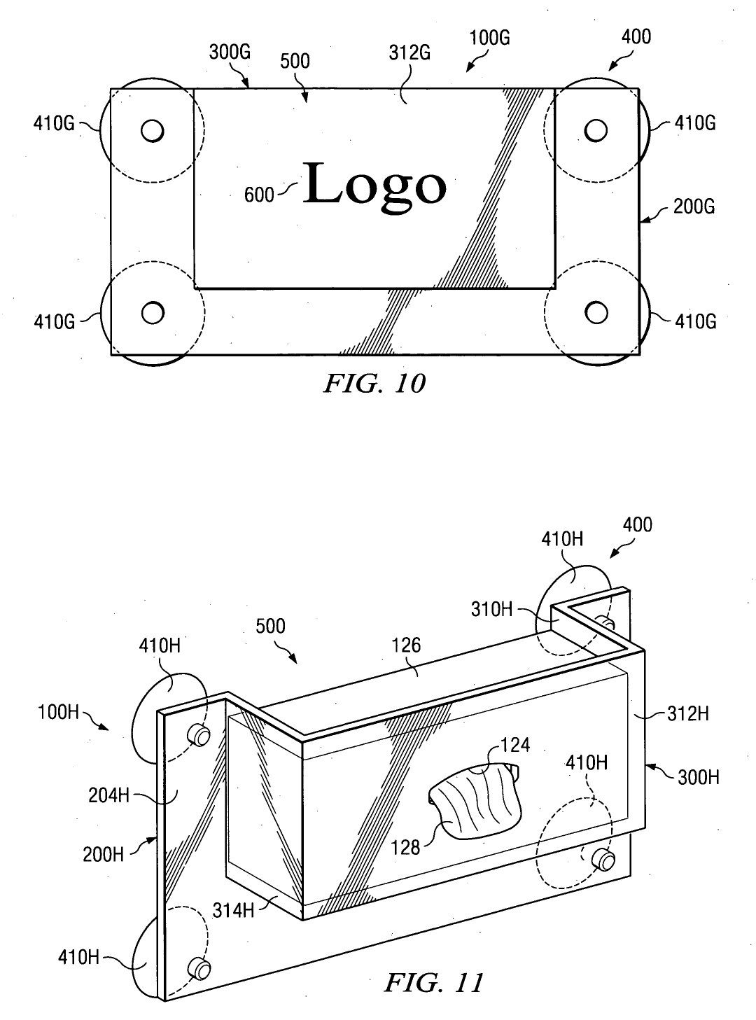

FIG. 5 illustrates the mounting of a container 100C to a window 1000 of a vehicle. While shown generally as a side-window, the window 1000 can be a front windshield, a rear windshield, side windows, sunroof or moon-roof windows, cab windows, and the like. The container 100C is similar to the container 100 of FIGS. 1 and 2, including the mounting surface 200, the container walls 300, and the attachment devices 400. The particular attachment devices 400 shown in this configuration are suction cups 410. Generally, the attachment devices 400 in this configuration are not positioned between the container space 500 and the surface of the vehicle, window 1000; however, in other configurations the attachment devices 400 can be positioned between the surface of the vehicle and the container space 500. For example, with reference to FIG. 4., the mounting of suction cups 410 to the mounting holes 218B would position the attachment devices 400 between the surface of the vehicle and the container space 500 upon mounting the container 100B to the surface of the vehicle. In yet other configurations—e.g., configurations with larger suction cups 410G (FIG. 10), only a portion of the attachment device 400 is positioned between the surface of the vehicle and the container space 500.

FIG. 6 illustrates the mounting of a container 100D to a visor 1100. The container 100D is similar to the container 100 of FIGS. 1 and 2, including mounting surface 200D, the container walls 300D, and the attachment devices 400. In this configuration, the attachment devices 400 are clips 420; however, other similar attachment devices 400 can be utilized as would be understood by one of ordinary skill in the art. The mounting surface 200D is generally shown flush with the visor 1100, which is the surface of the vehicle. Similar to FIG. 5, the attachment devices 400 in this configuration are not positioned directly between the container space 500 and the surface of the vehicle, visor 1100.

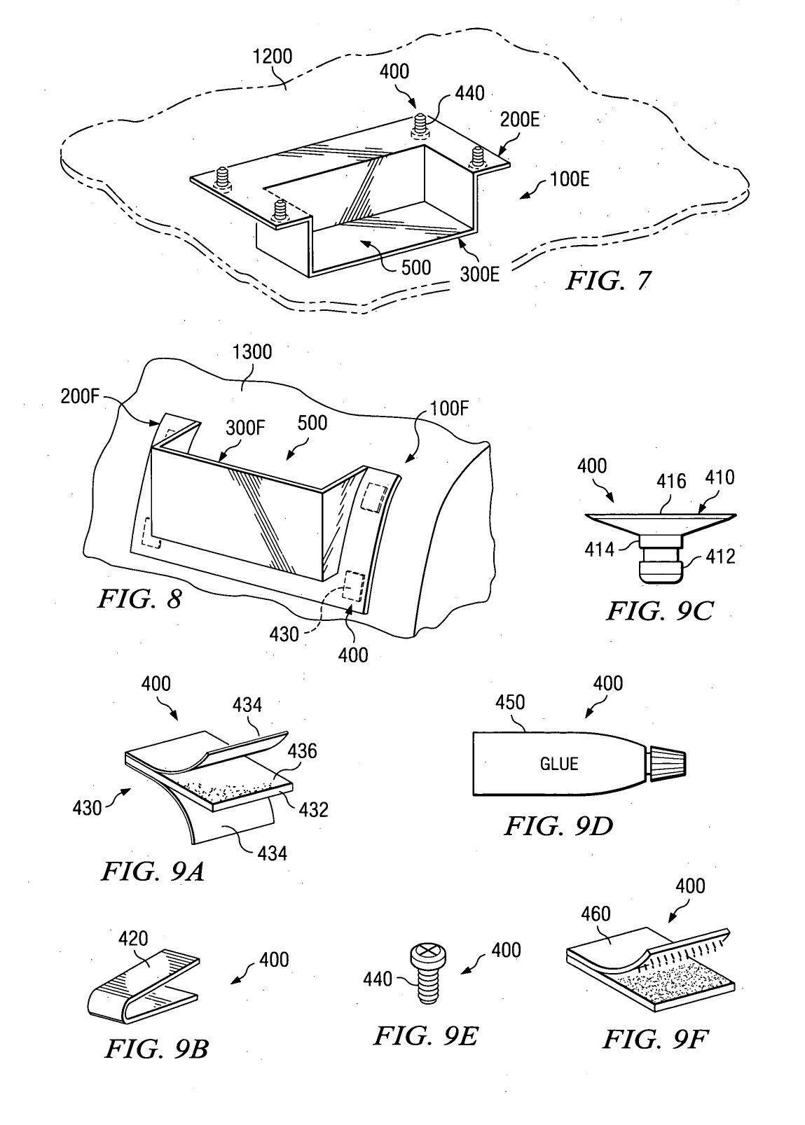

FIG. 7 illustrates the mounting of a container 100E to the internal roof 1200 of a vehicle. The container 100E is similar to the container 100 of FIGS. 1 and 2, including mounting surface 200E, container walls 300E, and attachment devices 400. In this configuration, the attachment devices 400 can be screws 440 (better seen in FIG. 9E). Other similar attachment devices 400 should become apparent to one of ordinary skill in the art. The mounting surface 200E is generally shown flush with the roof 1200, which is the surface of the vehicle. Similar to FIGS. 5 and 6, the attachment devices 400 in this configuration are not positioned between the container space 500 and the surface of the vehicle, roof 1200.

FIG. 8 illustrates the mounting of a container 10OF to a curved dashboard 1300 of a vehicle. The container 100F is similar to the container 100 of FIGS. 1 and 2, including mounting surface 200F, the container walls 300F, and the attachment devices 400. The mounting surface 200F is generally shown as complimenting the vehicle surface—an arced or curved configuration. In this configuration, the attachment devices 400 can be a peel and stick attachment 430, discussed in more detail below. The mounting surface 200F is generally shown flush with the dashboard 1300, which is the surface of the vehicle. Similar to FIGS. 5, 6 and 7, the attachment devices 400 in this configuration are not positioned directly between the container space 500 and the surface of the vehicle, which is shown as the dashboard 1300.

With reference to FIGS. 5-8, it can be seen that the container 100 can take on a variety of configurations. The configurations of the container 100 shown and described herein are intended as only being illustrative of several of the many configurations that can be utilized.

FIGS. 9A, 9B, 9C, 9D, 9E, and 9F illustrate various types of attachment devices 400 that can be utilized with the container 100. The figures and discussion, associated therewith, are intended as only illustrating some of the attachment devices 400 that can be utilized. Others will become apparent to one of ordinary skill in the art, including not only those that are now known, but also those that are later developed.

FIG. 9A shows a peel and stick attachment 430 with adhesive pad 432, protective films 434, and adhesive surface 436. The operation of such an attachment device 400 is known in the art. As an example and intended for illustrative purposes only, one of the protective films 434 can be peeled away to expose one of the adhesive surfaces 436 of the adhesive pad 432. The exposed adhesive surface 436 is placed on the container 100, binding the container 100 to the peel and stick attachment 430. Then, the other protective film 434 is removed, exposing the other adhesive surface 436, which can be placed on a surface of the vehicle—binding the container 100 to the surface of the vehicle via the two adhesive surfaces 436 of the peel and stick attachment 430.

FIG. 9B is a clip 420 which works with springlike resiliency—that is, a tendency to remain in a pre-defined natural position. Other similar clips with varied design configurations may be used as desired. Many of these types of clips, including the one shown in FIG. 9B, allow for the easy removability of the container 100 from the surface of the vehicle.

FIG. 9C is a side view of a circular suction cup 410 with a stem 412, a base 414, and concave cup portion 416. A brief discussion of a suction cup is provided above. Other similar suction cups should become apparent to one of ordinary skill in the art. Similar to the clip 420 and several varied configurations associated therewith, several configurations of the suction cup 410 provide an ease of removability of the container 100 from the surface of the vehicle.

FIG. 9D is glue 450. Any type of glue 450 suitable for the intended purposes can be utilized.

FIG. 9E is a screw 440. Various types of screws 440 should become apparent to one of ordinary skill in the art, including plastic screws and screws that utilize blind hole fasteners.

FIG. 9F is a hook and loop fastener system 460. An example of one type of hook and loop fastener system is that which is marketed under the trademark VELCRO.

FIG. 10 illustrates a back side view of a configuration of a container 100G. The container 100G is similar to the container 100 of FIGS. 1 and 2, including mounting surface 200G, the container walls 300G, and the attachment devices 400. The attachment devices 400 are large suction cups 410G (shown partially in phantom view). In the configuration of the container 100G of FIG. 10, there is a logo 600, or other advertising material, placed on the outer surface of the front container wall 312G or the inner surface of the container wall 300G. The logo 600 can be words or pictures, typically used to designate a manufacturer, product, or trademark associated therewith. The logo 600 can be applied to the surface of the front container wall 312G as a decal, paint or any other suitable coloring mechanism. Other methods of placing a logo 600 onto the container 100G should become apparent to one of ordinary skill in the art—e.g., laser etching and the like. When the container 100G is placed on a transparent window of the vehicle, the logo 600 can be viewed through the window. The logo 600 or other advertising may be placed on the mounting surface 200G as well.

FIG. 11 illustrates a front view of configuration of a container 100H. The container 100H is similar to the container 100 of FIGS. 1 and 2, including the mounting surface 200H, the container walls 300H, and the attachment devices 400. The attachment devices are large suction cups 410H. A dispenser hole 124 is situated, in certain implementations, in the center of the front container wall 312H. A box 126 containing tissues 128 or other products, such as moist toilettes, is placed in the container space 500. Preferably, the container space 500 is shaped to hold the box 126. This arrangement allows the container 100H to serve as a tissue holder.

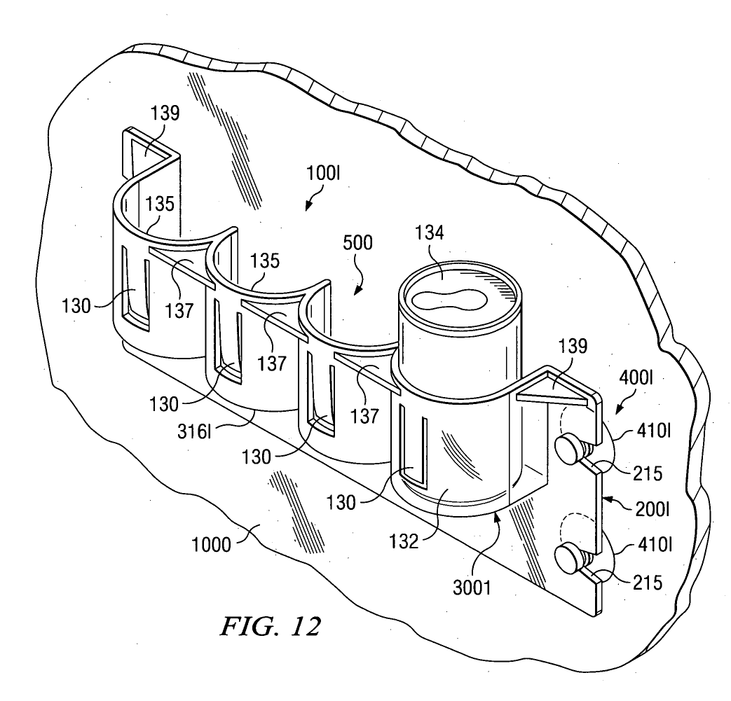

FIG. 12 illustrates a front view of another configuration of a container 100I. The container 100I includes a mounting surface 200I, the container walls 300I, and the attachment devices 400. The attachment devices 400 are shown as suction cups 410I, which have been slidably positioned to the mounting surface 200I upon placement onto mounting grooves 215. The container walls 300I in this configuration include a single multi-curved surface 132, which communicates with a bottom container wall 316I. The container space or volume 500 is defined by the curved surface 132, the bottom container wall 316I and the surface of the vehicle, which is a window 1000. In accordance with this aspect of the invention, the container space or volume 500 creates spaces suitable for holding multiple beverages, in particular beverage cans 134. It will be apparent to those having skill in the art that the container space or volume 500 may be altered to suit other forms and sizes of beverage containers. Resilient clips 130 may be fashioned in the curved surface 132, which is the container wall, to help hold the beverage cans 134 in the container space 500—e.g., the beverage cans 134 pushes the spring or clip 130 out upon placement of the beverage can 134 in the container space 500.

In one configuration, the curved surface 132 comprises a plurality of vertically extending semi-circular or arcuate sections 135. The container space 500 need not be fully enclosed and the arcuate sections 135 need not be joined to form the curved surface 132. If desired, the size, shape, location and orientation of the curved surface 132 may be selected to accommodate a particular pre-determined product. Additionally shown in FIG. 12 are ridges 137 disposed between the arcuate sections 135. A support member 139 is shown coupled between multi-curved surface 132 and the mounting surface 200I.

Thus, it is apparent that there has been provided, in accordance with the present invention, a vehicle container and corresponding methods of the making a container space that satisfy one or more of the advantages set forth above. Although the preferred embodiment has been described in detail, it should be understood that various changes, substitutions, and alterations can be made herein without departing from the scope of the present invention, even if all of the advantages and benefits identified above are not present. For example, the various elements or components may be combined or integrated in another system or certain features may not be implemented. Also, the techniques, systems, sub-systems, and methods described and illustrated in the preferred embodiment as discrete or separate may be combined or integrated with other systems, techniques, or methods without departing from the scope of the present invention. For example, any of the various attachment devices 400 can be used with any of the various configurations of the container 100. The manufacturing of a vehicle container may be achieved through injection molding, metal fabrication, or any known or available technique suitable for making vehicle containers. Other examples of changes, substitutions, and alterations are readily ascertainable by one skilled in the art and could be made without departing from the spirit and scope of the present invention.

1. A container, arranged and designed for coupling to a surface of a vehicle, the container comprising:
a mounting surface;
at least one container wall coupled to the mounting surface; and
an attachment device operable to couple the mounting surface to the surface of the vehicle, wherein the at least one container wall and the mounting surface are configured such that a container space is created by at least a portion of the at least one container wall and at least a portion of the surface of the vehicle when the container is coupled to the surface of the vehicle.

2. The container of claim 1, wherein the attachment device is configured such that the container is removable from the surface of the vehicle.

3. The container of claim 1, wherein the container space is further defined by the mounting surface.

4. The container of claim 1, wherein the mounting surface is configured to compliment the surface of the vehicle.

5. The container of claim 1, wherein the attachment device is not positioned between the container space and the surface of the vehicle.

6. The container of claim 1, wherein the mounting surface is configured to be positioned proximate to the surface of the vehicle upon coupling the mounting surface to the surface of the vehicle.

7. The container of claim 1, wherein the at least one container wall and the mounting surface are formed as a single piece.

8. The container of claim 1, wherein the attachment device is removable from the mounting surface.

9. The container of claim 1, wherein a dispenser hole is positioned in a side of the at least one container wall.

10. The container of claim 1, wherein the container space is configured to hold a beverage container.

11. The container of claim 1, wherein the attachment device is a suction cup.

12. The container of claim 1, wherein the attachment device is selected from the group consisting of glue, clips, screws, and hook and loop fasteners.

13. The container of claim 1, wherein the surface of the vehicle is selected from the group consisting of glass, visor, dashboard, and roof of the vehicle.

14. The container of claim 1, wherein a material for the container is selected from the group consisting of metals, plastics, papers, and woods.

15. The container of claim 1, wherein the at least one container wall includes an advertisement.

16. A container, arranged and designed for mounting on a surface of a vehicle, the container comprising:
a mounting surface, wherein at least a portion of the mounting surface is configured to compliment the surface of the vehicle;
an attachment device operable to couple the mounting surface to the surface of the vehicle; and
at least one container wall configured such that a at least a portion of a container space is created by at least a portion of the at least one container wall when the container is coupled to the surface of the vehicle, wherein
the at least one container wall is coupled to the mounting surface,
the container space is adjacent the surface of the vehicle, and
the attachment device is not positioned between the container space and the surface of the vehicle.

17. The container of claim 16, wherein the at least one container wall and the mounting surface are configured such that the container space is defined by at least a portion of the at least one container wall and at least a portion of the surface of the vehicle.

18. The container of claim 16, wherein the at least one container wall includes a back wall proximate to the surface of the vehicle which the container is mounted to the surface of the vehicle.

19. The container of claim 16, wherein the at least one container wall is integrated with the mounting surface as a single piece.

20. The container of claim 16, wherein the attachment device is configured such that the container is removable from the surface of the vehicle.

21. The container of claim 16, wherein the mounting surface is configured to conform with the surface of the vehicle.

22. The container of claim 16, wherein the mounting surface is configured to be positioned flush with the surface of the vehicle upon coupling the mounting surface to the surface of the vehicle.

23. The container of claim 16, wherein the attachment device is removable from the mounting surface.

24. The container of claim 16, wherein a dispenser hole is positioned in the side of the at least one container wall.

25. The container of claim 16, wherein the container space is configured to hold a beverage container.

26. The container of claim 16, wherein the attachment device is a suction cup.

27. The container of claim 16, wherein the attachment device is selected from the group consisting of glue, clips, screws, and hook and loop fasteners.

28. The container of claim 16, wherein the surface of the vehicle is selected from the group consisting of glass, visor, dashboard, and roof of the vehicle.

29. The container of claim 16, wherein a material for the container is selected from the group consisting of metals, plastics, papers, and woods.

30. The container of claim 16, wherein the at least one container wall includes a logo.

31. The container of claim 16, wherein the at least one container wall includes four walls.

32. A method of creating a container space within a vehicle, the method comprising:
providing a mounting surface with at least one container wall coupled thereto; and
mounting the mounting surface to a surface of the vehicle such that at least a portion of surface of the vehicle and at least a portion of the at least one container wall form the container space.

33. The method of claim 32, further comprising:
providing an advertisement on the at least one container wall.

34. The method of claim 32, further comprising:
utilizing an attachment device in mounting the mounting surface to a surface of the vehicle, wherein the attachment device is not positioned between the container space and the surface of the vehicle.
